(19) United States
(12) Patent Application Publication
(10) Pub. No.: US 2026/0336099 A1
(43) Pub. Date: Oct. 29, 2026

(54) SYSTEMS AND METHODS FOR PHYSICS-INFORMED AUTONOMOUS ROBOT MOTION PLANNING

(71) Applicant: Purdue Research Foundation, West Lafayette, IN (US)

(72) Inventors: Ahmed Hussain QURESHI, West Lafayette, IN (US); Ruiqi NI, West Lafayette, IN (US)

(21) Appl. No.: 19/483,932

(22) PCT Filed: May 17, 2024
(86) PCT No.: PCT/US2024/030074

§ 371 Date: Nov. 12, 2025

Related U.S. Application Data
(60) Provisional application No. 63/503,422, filed on May 19, 2023.

(51) Int. Cl. B25J 9/16; G05B 13/02

(52) U.S. Cl. CPC B25J 9/161; B25J 9/163; B25J 9/1666; G05B 13/027

(57) ABSTRACT

Methods and systems for autonomous robot motion planning are disclosed. The methods and systems using the methods include: obtaining, by an electronic processor, robot configuration training data, the robot configuration training data comprising a start configuration and a goal configuration; applying, by the electronic processor, the start configuration and the goal configuration to a neural network model to obtain a time field; determining, by the electronic processor, a predicted speed indication based on the start configuration, the goal configuration, and the time field; obtaining, by the electronic processor, a ground truth speed indication; and training, by the electronic processor, the neural network model based on a loss between the predicted speed indication and the ground truth speed indication. Other aspects, embodiments, and features are also claimed and described.

### CROSS-REFERENCE TO RELATED APPLICATION(S)

This application is based on, claims priority to, and incorporates herein by reference in its entirety U.S. Provisional Application Ser. No. 63/503,422, filed on May 30, 2023.

### STATEMENT OF GOVERNMENT SUPPORT

N/A

### TECHNICAL FIELD

The technology discussed below relates to robot motion planning.

### BACKGROUND

Motion Planning (MP) is one of the components of an autonomous robot system that aims to interact physically with its surrounding environments. MP algorithms find path solutions from the robot's start state to the goal state while respecting all constraints, such as collision avoidance. The quest for fast, scalable MP methods has led from traditional approaches that exhibit promising performance in high-dimensional spaces. However, a significant bottleneck in state-of-the-art MP methods is the need for expert trajectories from traditional MP methods, limiting their application to high-dimensional scenarios where large-scale data generation is time-consuming. As the demand for autonomous robot systems continues to increase, research and development continue to advance robot motion planning technologies to meet the growing demand for improved processing path solutions of autonomous robots in motion planning.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method, a system, and/or an apparatus for autonomous robot motion planning is disclosed. The method, the system, and/or the apparatus using the method includes: obtaining, by an electronic processor, robot configuration training data, the robot configuration training data comprising a start configuration and a goal configuration; applying, by the electronic processor, the start configuration and the goal configuration to a neural network model to obtain a time field; determining, by the electronic processor, a predicted speed indication based on the start configuration, the goal configuration, and the time field; obtaining, by the electronic processor, a ground truth speed indication; training, by the electronic processor, the neural network model based on a loss between the predicted speed indication and the ground truth speed indication; and causing a path solution to be loaded onto a robot for movement of the robot within an environment.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for autonomous robot motion planning according to some embodiments.

FIG. 2 is a flow diagram illustrating an example process for autonomous robot motion planning training according to some embodiments.

FIG. 3 illustrates an example neural network model for autonomous robot motion planning according to some embodiments.

FIG. 4A illustrates an example architecture of a c-space encoder according to some embodiments. FIG. 4B illustrates an example architecture of a time field generator according to some embodiments.

FIG. 5 illustrates another example neural network model for autonomous robot motion planning according to some embodiments.

FIG. 6A illustrates an example architecture of a c-space encoder according to some embodiments. FIG. 6B illustrates an example architecture of a workspace encoder according to some embodiments. FIG. 6C illustrates an example architecture of a time field generator according to some embodiments.

FIG. 7 shows an effect of viscosity coefficient on the correctness of time field results according to some embodiments.

FIG. 8 shows an example progressively decreasing speed around obstacles using parameter, which leads to continuous interpolation of speed and time fields in the given environment according to some embodiments.

FIG. 9 is a flow diagram illustrating an example process for autonomous robot motion planning according to some embodiments.

FIG. 10 shows an example of a robot moving based on the path solution according to some embodiments.

FIG. 11 shows another example of a robot moving based on the path solution according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

### Example Autonomous Robot Planning System

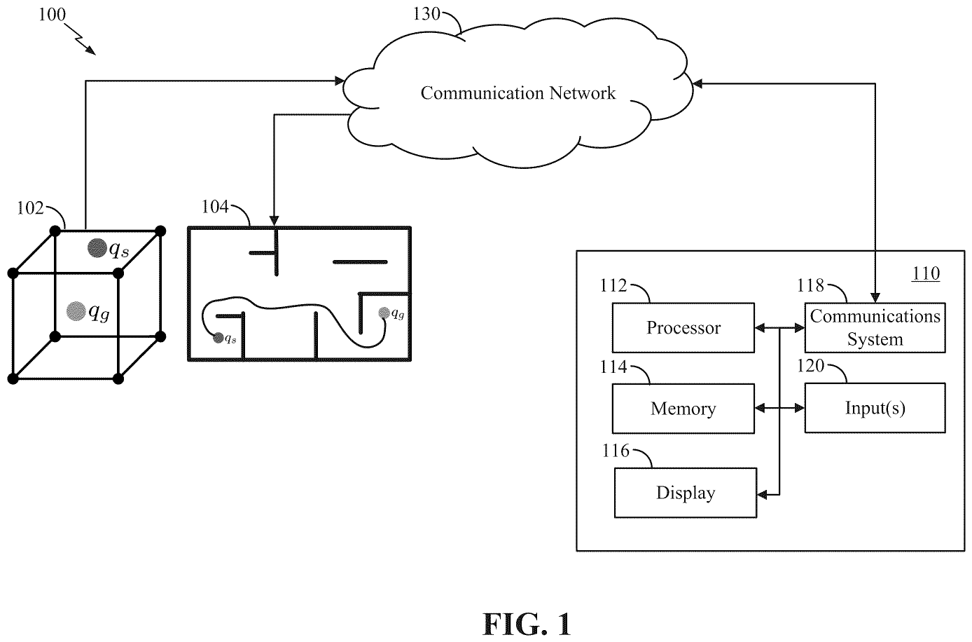

FIG. 1 shows a block diagram illustrating a system for autonomous robot motion planning according to some embodiments. In some examples, a computing device 110 can obtain or receive robot configuration training/runtime data 102 including a start configuration and a goal configuration, a configuration space, a work space, obstacles on the configuration space, obstacles on the workspace, an obstacle-free configuration space, an obstacle-free workspace, and/or a ground truth speed indication from a user and/or a system via the communication network 130, produce a path solution 104 from the start configuration to the goal configuration, and move a robot according to the path solution 104.

In further examples, the computing device 110 can include a processor 112. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

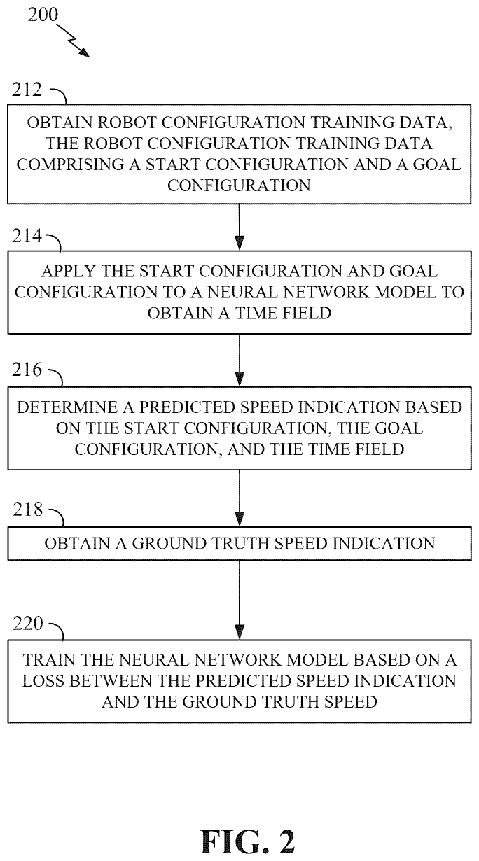

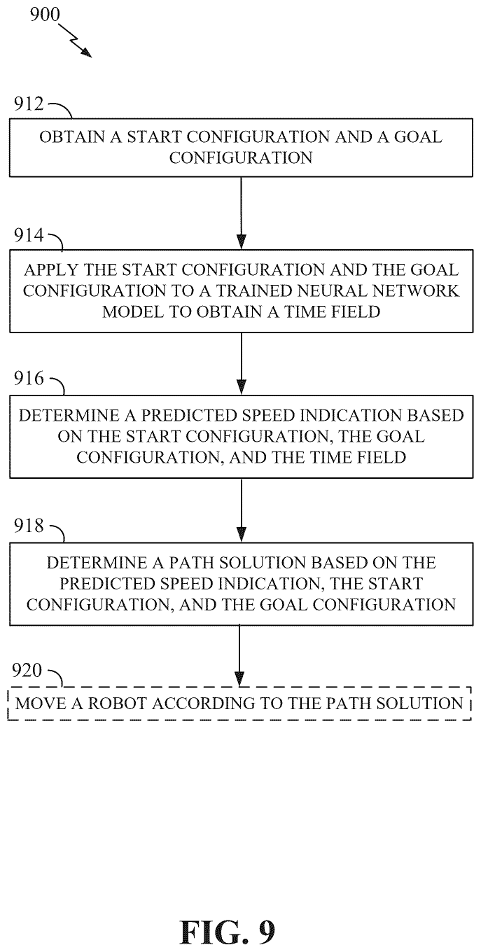

In further examples, the computing device 110 can further include a memory 114. The memory 114 can include any suitable storage device or devices that can be used to store suitable data (e.g., robot configuration training/runtime data 102, a configuration space, a work space, obstacles on the configuration space, obstacles on the workspace, an obstacle-free configuration space, an obstacle-free workspace, and/or a ground truth speed indication, neural network model, etc.) and instructions that can be used, for example, by the processor 112 to obtain robot configuration training data, the robot configuration training data comprising a start configuration and a goal configuration; apply the start configuration and the goal configuration to a neural network model to obtain a time field; determine a predicted speed indication based on the start configuration, the goal configuration, and the time field; obtain a ground truth speed indication; train the neural network model based on a loss between the predicted speed indication and the ground truth speed indication; obtain an obstacle-free configuration space; combine a first output of the first encoder and a second output of the second encoder using a non-linear symmetric operator to produce a combined output; apply the start configuration and the goal configuration to a trained neural network model to obtain a time field; determine a path solution based on the predicted speed indication, the start configuration, and the goal configuration; and move a robot according to the path solution. The memory 114 can include any suitable volatile memory, non-volatile memory, storage, or any suitable combination thereof. For example, memory 114 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 112 can execute at least a portion of process 200 or 900 described below in connection with FIG. 2 or 9.

In further examples, computing device 110 can further include communications system 118. Communications system 118 can include any suitable hardware, firmware, and/or software for communicating information over communication network 140 and/or any other suitable communication networks. For example, communications system 118 can include one or more transceivers, one or more communication chips and/or chip sets, etc. In a more particular example, communications system 118 can include hardware, firmware and/or software that can be used to establish a Wi-Fi connection, a Bluetooth connection, a cellular connection, an Ethernet connection, etc.

In further examples, computing device 110 can receive or transmit information (e.g., robot configuration training/runtime data 102, a configuration space, a work space, obstacles on the configuration space, obstacles on the workspace, an obstacle-free configuration space, an obstacle-free workspace, and/or a ground truth speed indication, neural network model, a path solution 104, etc.) and/or any other suitable system over a communication network 130. In some examples, the communication network 130 can be any suitable communication network or combination of communication networks. For example, the communication network 130 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 130 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, computing device 110 can further include a display 116 and/or one or more inputs 120. In some embodiments, the display 116 can include any suitable display devices, such as a computer monitor, a touchscreen, a television, an infotainment screen, etc. to display the report, the human activity indication 140, or any suitable result of the path solution 104. In further embodiments, and/or the input(s) 120 can include any suitable input devices (e.g., a keyboard, a mouse, a touchscreen, a microphone, etc.).

### Example Autonomous Robot Motion Planning Training Process

FIG. 2 is a flow diagram illustrating an example process 200 for autonomous robot motion planning training in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., computing device 110, processor 112 with memory 114, etc.) in connection with FIG. 1 can be used to perform example process 200. However, it should be appreciated that any suitable apparatus or means for carrying out the operations or features described below may perform process 200.

At step 212, the process 200 can obtain a robot configuration training data. In some examples, the robot configuration training data can include a start configuration and a goal configuration. In some examples, the start configuration and the goal configuration can be a location (e.g., an absolute location, a relative location, or any other suitable location) or a coordinate (e.g., an absolute coordinate, a relative coordinate, or any other suitable coordinate) on a configuration space. In some examples, the configuration can be used by a robot manipulator (e.g., joint angles), a vehicle (e.g., position and steering angle), etc. In further examples, the coordinate can include a global positioning system-based coordinate, a radar-based position, etc. In some examples, a configuration space can be a mathematical representation of all possible configurations that a robot can attain in its workspace. In some examples, the configuration space is a transformed space from the physical space in which the robot is of finite-size. In some examples, the configuration space can be obtained by shrinking the robot to a point while growing the obstacles by the size of the robot. In further examples, the configuration space can have a suitable dimension. For example, if a robot has a 6-DOF (degree-of-freedom) arm, the configuration space would be a six-dimensional space that includes all the possible joint angles that the arm can take.

In some examples, the training data can contain sampled start and goal pairs in robot c-space randomly. In some examples, robot c-space to [−0.5,0.5] can be normalized on each dimension. Then, the c-space sample range can be defined as a hypercube, i.e., all dimensions have the same range scale. Furthermore, the speed can be computed for those configurations using the speed model. In some examples, the workspace point cloud can include 20000 points on the workspace obstacle surface, which is converted into 128×128×128 occupied voxel grid.

In some examples, the process 200 can obtain an obstacle-free configuration space (c-space). In some examples, the obstacle-free configuration space can indicate a configuration space excluding one or more obstacle configurations. In some examples, although the c-space is the obstacle-free configuration space, the configuration space might include one or more obstacles, which can be ignored or overcome by the robot. In further examples, the start configuration and the goal configuration are on the obstacle-free configuration space. In some examples, the start configuration and the goal configuration are randomly sampled configurations on the obstacle-free configuration space. In further examples, there can be multiple sets (training epochs) of the start configuration and the goal configuration for training the neural network model or the machine learning model, which is described in connection with step 220.

In some examples, the configuration space and the environment space can be denoted as [symbol] ⊂ [symbol] ^{d} and X [symbol] ⊂ [symbol] ^{m}, where {m, d}∈ [symbol] represents their dimensionality. The obstacles in the environment, denoted as [symbol] _{obs}⊂ [symbol] , form a formidable robot configuration space (c-space) defined as [symbol] _{obs}⊂ [symbol] . Finally, the feasible space in the environment and c-space (i.e., the obstacle-free c-space) is represented as [symbol] _{free}= [symbol] \ [symbol] _{obs} and Q_{free}=Q\Q_{obs}, respectively. The objective of robot motion planning algorithms is to find a trajectory τ⊂Q_{free} that connects the given robot start qₛ∈ [symbol] _{free} and goal q_{g}∈Q_{free} configurations.

At step 214, the process 200 can apply the start configuration and a goal configuration to a neural network model to obtain a time field. In some examples, the motion planning problems can be viewed as the solution to a partial differential equation (PDE), specifically focusing on solving the Eikonal equation. In some examples, the physics governed by an Eikonal equation can be modeled using a deep neural network.

The Eikonal equation, a first-order non-linear PDE, allows finding the shortest trajectory between the start configuration (qₛ) and the goal configuration (q_{g}) under speed constraints by relating a predefined speed model S(q) at configuration q_{g} to the arrival time T(qₛ, q_{g}) from qₛ to q_{g} as follows:

$$\frac{1}{S ( {q}_{g} )} = ‖ {∇}_{{q}_{g}} T ( {q}_{s} , {q}_{g} ) ‖ \qquad Equation 1$$

The ∇_{q}_{_{g}}T(qₛ,q_{g}) is the partial derivative of the arrival time T(qₛ,q_{g}) function with respect to q_{g}. Therefore, finding a trajectory connecting the given start and goal requires solving the PDE under a predefined speed model and arrival time function. The arrival time function can be factorized as follows:

$$T ( {q}_{s} , {q}_{g} ) = \frac{‖ {q}_{s} - {q}_{g} ‖}{τ ( {q}_{s} , {q}_{g} )} \qquad Equation 2$$

The neural network model is designed to produce τ(qₛ, q_{g}), the factorized time field for the given qₛ (the start configuration) and q_{g} (the goal configuration).

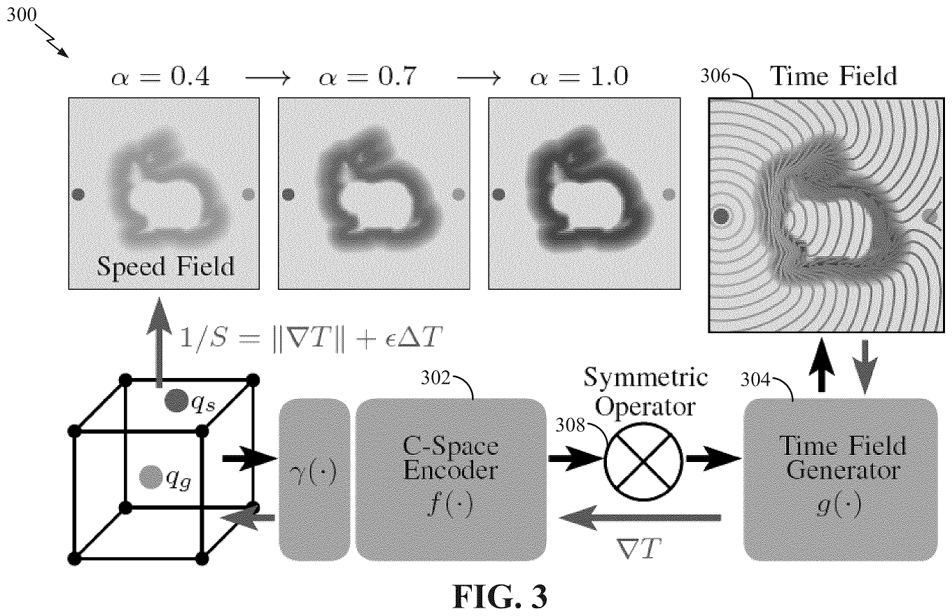

FIG. 3 illustrates an example neural network model 300 for autonomous robot motion. In some examples, the neural network model 300 can include a c-space encoder 302 and a time field generator 304. In some examples, the c-space encoder 302 can be for the start configuration and the goal configuration. The time field generator 304 can generate the time field 306. In some examples, the c-space encoder 302 can include a first encoder and a second encoder. For example, the first encoder can receive a first robot configuration embedding for the start configuration while the second encoder can receive a second robot configuration embedding for the goal configuration. In some examples, each of the first robot configuration embedding and the second robot configuration embedding is calculated using a random Fourier technique.

For example, given the robot's start (qₛ) and goal (q_{g}) configurations, and the random environment latent code b∈R^{d×h}, the random Fourier feature γ can be computed for obtaining high-frequency robot configuration embeddings, i.e.,

γ(qₛ)=[cos(2πb^{T}qₛ),sin(2πb^{T}qₛ)]

γ(q_{g})=[cos(2πb^{T}q_{g}),sin(2πb^{T}q_{g})] Equation 3

In some examples, the latent code b is of dimension d×h∈N×N (h is the hidden unit number) and represents the given environment. Although the latent code can be obtained in numerous ways, such as using auto-encoders to embed environment point clouds, a fixed, unique random matrix can be assigned to each environment for the representation. In further examples, the features can be further processed into a latent embedding by a C-space encoder ƒ(·), which is a ResNet-style multi-layer perception.

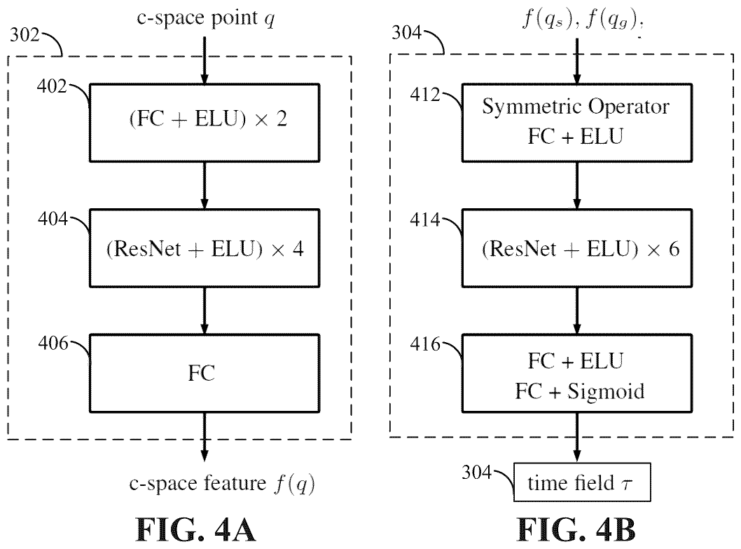

FIG. 4A illustrates an example architecture of a c-space encoder 302. In some examples, each of the first encoder and the second encoder of the c-space encoder 302 can include a first component 402, a second component 404, and a first fully connected layer 406. For example, the first component 402 can include a second fully connected layer and a first exponential linear unit layer. In some examples, the first component can receive the start configuration for the first encoder and the goal configuration for the second encoder. In further examples, the first component can produce a first component output. In further examples, the first component 402 can include two sets of the second fully connected layer and the first exponential linear unit layer. In some examples, the second component 404 can include a residual neural network and a second exponential linear unit layer. In further examples, the second component can receive the first component output and to produce a second component output. In some examples, the second component 404 can include four sets of the residual neural network and the second exponential linear unit layer. In some examples, the first fully connected layer 406 can receive the second component output and produce the first robot configuration embedding or the second robot configuration embedding.

Referring again to FIG. 3, in some examples, the process 200 can further combine a first output of the first encoder and a second output of a second the second encoder using a non-linear symmetric operator 308 to produce a combined output. In some examples, the combined output can include a maximum value in the first robot configuration embedding and the second robot configuration embedding, and a minimum value in the first robot configuration embedding and the second robot configuration embedding.

For example, to combine features ƒ(γ(qₛ)) (i.e., the first output of the first encoder) and ƒ(γ(q_{g})) (i.e., the second output of the second encoder), the non-linear symmetric operator ⊗ 308. In some examples, the operator ⊗ 308 concatenates the max and min of two given features together, i.e., ƒ(γ(qₛ))⊗ƒ(γ(q_{g}))=[max(f(γ(qₛ)), ƒ(γ(q_{g}))), min(f(γ(qₛ)), ƒ(γ(q_{g})))]. In further examples, the ⊗ operator 308 can lead to improved performance in predicting the speed and time fields.

In some examples, the time field generator 304 can receive the combined output and produce the time field 304. FIG. 4B illustrates an example architecture of a time field generator 304. In some examples, the time field generator 304 can include a first component 412, a second component 414, and a third component 416. In some examples, the first component 412 can include a first fully connected layer and a first exponential linear unit layer 416. In further examples, the first component 412 can receive the combined output and produce a first component output. In further examples, the second component 414 can include a residual neural network and a second exponential linear unit layer. The second component 414 can receive the first component output and produce a second component output. In further examples, the third component 416 can include a second fully connected layer, a third exponential linear unit layer, a third fully connected layer, and a sigmoid layer. In further examples, the third component 416 can receive the second component output and produce the time field.

For example, the time field generator network g can include a ResNet-style multi-layer perceptron, which takes the encoding ƒ(γ(qₛ))⊗ƒ(γ(q_{g})) and outputs the factorized time field τ 306, i.e.,

τ(qₛ,q_{g})=g(f(γ(qₛ))⊗ƒ(γ(q_{g}))) Equation 4

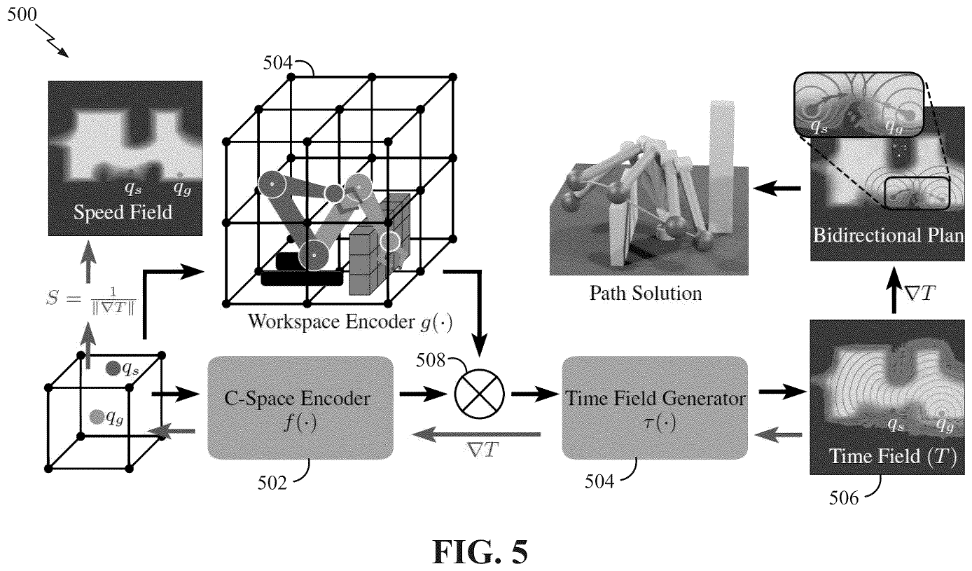

FIG. 5 illustrates another example neural network model 500 for autonomous robot motion. In some examples, the neural network model 500 can include the c-space encoder (f(·)) 502 and a workspace encoder (g(·)) 504 configured to receive the start configuration and the goal configuration. In some examples, the input to the neural network model 500 can include workspace point cloud, which can be converted into a voxel grid X, and the robots start qₛ and goal q_{g} configuration in M-dimensional c-space. In some examples, the forward kinematic function can be used to compute the robot surface points associated with the given configuration. In some examples, an output of the c-space encoder 502 and an output of the workspace encoder 504 can be combined to be provided to the time field generator 504. In further examples, the time field generator 504 can generate the time field 506. In some examples, for a given robot configuration q∈ [symbol] , the workspace and c-space encoders 502, 504 can generate the robot-centric workspace embedding g(q) and direct configuration embedding f(q). The workspace encoder 504 enables reasoning about the relative position of obstacles and the robot, including collisions, for decision-making. Whereas the c-space 502 allows direct computation of the gradient of time for input configurations needed for solving the Eikonal equation.

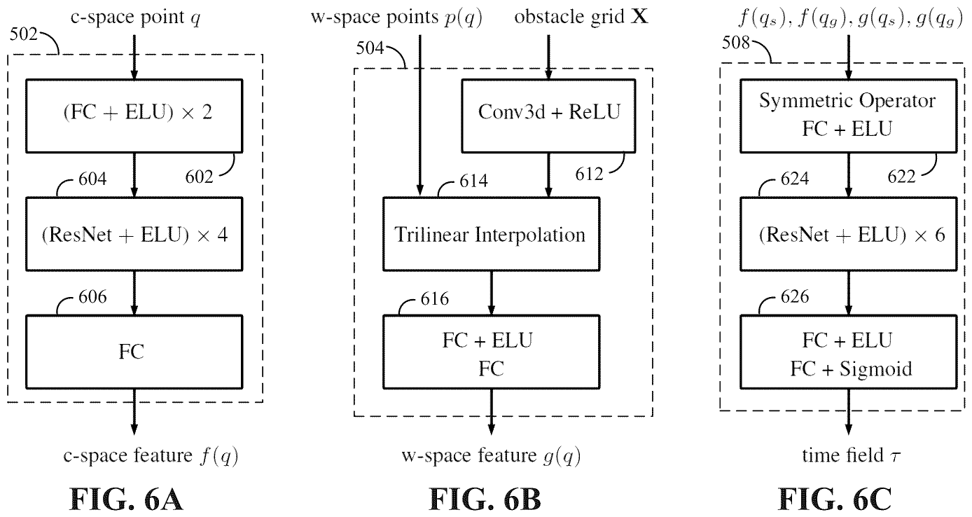

FIG. 6A illustrates an example architecture of a c-space encoder 502. In some examples, the c-space encoder 502 can include a first component 602, a second component 604, and a first fully connected layer 606. In some examples, the first component 602 can include a second fully connected layer and a first exponential linear unit layer. In further examples, the first component 602 can receive the start configuration and the goal configuration and produce a first component output. In some examples, the second component 604 can include a residual neural network and a second exponential linear unit layer. In further examples, the second component 604 can receive the first component output and produce a second component output. In some examples, the first fully connected layer 606 can receive the second component output and produce a first robot configuration embedding and a second robot configuration embedding. In some examples, the c-space encoder 502 is configured to produce the c-space encoder output. In further examples, the c-space encoder output can include: the first robot configuration embedding and the second robot configuration embedding.

For example, to compute a direct latent embedding of q, the c-space encoder 502 can use a ResNet-style feed-forward neural network, denoted as ƒ. Since the gradient of arrival time can be computed with respect to input configurations, the direct encoding of q with MLP-based ResNet blocks can allow gradient computation. In summary, the function ƒ can take the robot configuration q as an input, passes them through ResNet blocks, and outputs latent embedding.

In some examples, the workspace encoder 504 comprises a first component 612, a second component 614, and a third component 616. In some examples, the first component 612 can include a three-dimensional convolution layer and a residual neural network. In some examples, the first component 612 can receive an obstacle grid and produce a first component output. In some examples, the second component 614 can include a trilinear interpolation layer. In further examples, the second component 614 can receive the start configuration, the goal configuration, and the first component output. In further examples, the second component 614 can produce a second component output. In some examples, the third component 616 can include a first fully connected layer, a first exponential linear unit layer, and a second fully connected layer. In further examples, the third component 616 can receive the second component output and produce a first robot workspace embedding and a second robot workspace embedding. In some examples, the workspace encoder 504 can produce the workspace encoder output. In further examples, the workspace encoder output can include the first robot workspace embedding and the second robot workspace embedding.

For example, the process 200 can obtain the robot-centric workspace embedding g (q). First, the sparse workspace obstacle point-cloud X⊂ [symbol] can be sampled and can be converted into a voxel grid W₀ of dimension N×N×N×1, where the last dimension indicates each voxel's occupancy. Then, the W₀ can be passed through a 3D CNN layer to get the output W₁ of size N×N×N×K, where K is the number of feature maps. In some examples, the input W₀ and output W₁ have the same first 3D dimensions, which can be retained via padding. Next, W₀ and output W₁ can be combined such that the resulting workspace feature representation W becomes of the size N×N×N×(K+1). In some examples, the W is a multi-scale feature representation including both input and output layers of the 3D CNN module. To compute g(q) based on W and q, several samples {p₁, p₂, . . . , pₙ}∈p(q) can be generated on the robot surface p⊂ [symbol] ³ using forward kinematics (FK) at the given configuration q. In some examples, FK can allow computing robot joint positions in the workspace using the robot joint angles. Therefore, given all joints' positions and robot geometry, i.e., links' lengths and widths, the robot workspace representation as a point cloud, p(q), is obtained. In some examples, the robot surface points are in the workspace, as is the obstacle point cloud. Therefore, using both robot surface point cloud and obstacle point cloud to obtain workspace encoding enables reasoning about the relative position of obstacles and the robot itself, including collisions, for decision-making. To do so, the nearest grid cell in W can be computed for each point pᵢ. The grid cell can be a 3D cube with eight corners. Therefore the feature size for each grid cell is 8×(K+1). Next, the feature vectors 8×(K+1) are further combined via trilinear interpolation to form a representation for point pᵢ of size (K+1). A full robot-centric workspace representation g(q) becomes of size n×(K+1).

Referring again to FIG. 5, in some examples, the process 200 can combine a c-space encoder output and a workspace encoder output (e.g., using a nonlinear symmetric operator 508). For example, given a robot configuration, the c-space and workspace encoders 502, 504 can provide robot configuration embedding ƒ(q) and the robot-centric workspace representation g(q), as shown in FIG. 5.

In some examples, the combined output can include a first maximum value in the first robot configuration embedding and the second robot configuration embedding, a first minimum value in the first robot configuration embedding and the second robot configuration embedding, a second maximum value in the first robot workspace embedding and the second robot workspace embedding, and a second minimum value in the first robot workspace embedding and the second robot workspace embedding.

In some examples, to address the symmetry property of the Eikonal Equation, a nonlinear symmetric operator 508, denoted as ⊗, can be introduced to combine the features ƒ(qₛ), ƒ(q_{g}), g(qₛ), and g(q_{g}) to form an input to the time fields generator 504 predicting τ. In some examples, a nonlinear symmetric operator min and max can be chosen to combine the given feature vectors. However, since each of these operators loses some feature information, concatenating multiple operators' output can lead to better performance. Thus, in come examples, the robot configuration feature vectors can be combined by concatenating both min and max operations. Let the concatenation of two arbitrary vectors a and b be denoted as [a, b]. Then, the nonlinear operator ⊗ 508 can combine the arbitrary feature vectors a and b as a⊗b=[max(a, b), min(a, b)]. Therefore, the configuration feature vectors are combined as [ƒ(qₛ)⊗ƒ(q_{g}), g(qₛ)⊗g(q_{g})].

Referring to FIG. 6C, in some examples, the time field generator 504 can include a first component 622, a second component 624, and a third component 626. In some examples, the first component 622 can include a first fully connected layer and a first exponential linear unit layer. In further examples, the first component 622 can receive the combined output and produce a first component output. In some examples, the second component 624 can include a residual neural network and a second exponential linear unit layer. In further examples, the second component 624 can receive the first component output and produce a second component output. In some examples, the third component 626 can include a second fully connected layer, a second exponential linear unit layer, a third fully connected layer, and a sigmoid layer. In further examples, the third component 626 can receive the second component output and produce the time field.

For example, the time field generation function of the time field generator 504 is a ResNet-style neural architecture that takes the robot's start and target configuration embeddings, i.e., [ƒ(qₛ)⊗ƒ(q_{g}), g(qₛ)⊗g(q_{g})], and outputs the factorized time field τ.

At step 216, the process 200 can determine a predicted speed indication based on the start configuration, the goal configuration, and the time field. In some examples, to determine the predicted speed indication, the process 200 can determine an arrival time model based on the time field, the start configuration, and the goal configuration. In further examples, to determine the predicted speed indication, the process 200 can further determine the predicted speed indication based on a partial derivative of the arrival time model with respect to the goal configuration.

Given the arrival time function in Equation 2, the model time field T(qₛ, q_{g})=0 when qₛ=q_{g}. As the speed in formidable obstacle space is to be almost zero, τ(qₛ, q_{g})→0 can be made for any arbitrary configurations in obstacle space, i.e., {qₛ, q_{g}}∈ [symbol] _{obs}. Therefore, T(qₛ, q_{g})∈[0, ∞) and by the factorization in Equation 2, τ(qₛ, q_{g})'s value range from 0 to 1. Thus, the Eikonal equation in Equation 1 expands to the following using the chain rule:

$$S ( {q}_{g} ) = \frac{{τ}^{2} ( {q}_{s} , {q}_{g} )}{\sqrt{\begin{matrix}{τ}^{2} ( {q}_{g} - {q}_{s} ) - 2 τ ( {q}_{s} , {q}_{g} ) ( {q}_{g} - {q}_{s} ) \cdot {∇}_{{q}_{g}} \\ τ ( {q}_{s} , {q}_{g} ) + {‖ {q}_{s} - {q}_{g} ‖}^{2} {‖ {∇}_{{q}_{g}} τ ( {q}_{s} , {q}_{g} ) ‖}^{2}\end{matrix}}} \qquad Equation 5$$

In some examples, the method learns to output t and its partial derivative with respect to inputs via backpropagation using the Eikonal-based physics model, i.e., Equation 5.

In some examples, the predicted speed indication is determined further based on a gradient indication (i.e., εΔ_{q}_{_{g}}T(qₛ, q_{g})). In some examples, the Eikonal equation's exact solution has several problems that lead to neural network fitting issues. First, the solution is not differentiable at every point in space, which means a neural network cannot approximate the solution very well, especially for the sharp feature in low-speed environments. Second, the gradient ∇_{q}_{_{g}}T(qₛ, q_{g}) is not unique at these non-smooth points, which will also cause the neural network fitting issue because training is based on the supervision of the gradient ∇_{q}_{_{g}}T(qₛ, q_{g}).

To fix these problems, we propose to use a viscosity term that can provide a differentiable and unique approximation of the Eikonal equation's solution. The viscosity term comes from the vanishing viscosity method. It adds the Laplacian Δ_{q}_{_{g}}T(qₛ, q_{g}) to the Eikonal equation, i.e.,

$$\frac{1}{S ( {q}_{g} )} = ‖ {∇}_{{q}_{g}} T ( {q}_{s} , {q}_{g} ) ‖ + {ϵΔ}_{{q}_{g}} T ( {q}_{s} , {q}_{g} ) , \qquad Equation 6$$

where ε∈ [symbol] is a scaling coefficient. The resulting system in Equation 6 is a semi-linear elliptic PDE with a smooth and unique solution. The expansion of Equation 6 using the chain rule and the T described in Equation 7 becomes:

$$S ( {q}_{g} ) = \frac{1}{\begin{matrix}{ϵΔ}_{{q}_{g}} τ ( {q}_{s} , {q}_{g} ) + \\ \sqrt{\begin{matrix}2 ( {q}_{s} , {q}_{g} ) - 2 τ ( {q}_{s} , {q}_{g} ) ( {q}_{g} - {q}_{s} ) \cdot \\ {∇}_{{q}_{g}} τ ( {q}_{s} , {q}_{g} ) + {‖ {q}_{s} - {q}_{g} ‖}^{2} \times \\ {‖ {∇}_{{q}_{g}} τ ( {q}_{s} , {q}_{g} ) ‖}^{2} ] / {τ}^{4} ( {q}_{s} , {q}_{g} )\end{matrix}}\end{matrix}} \qquad Equation 7$$

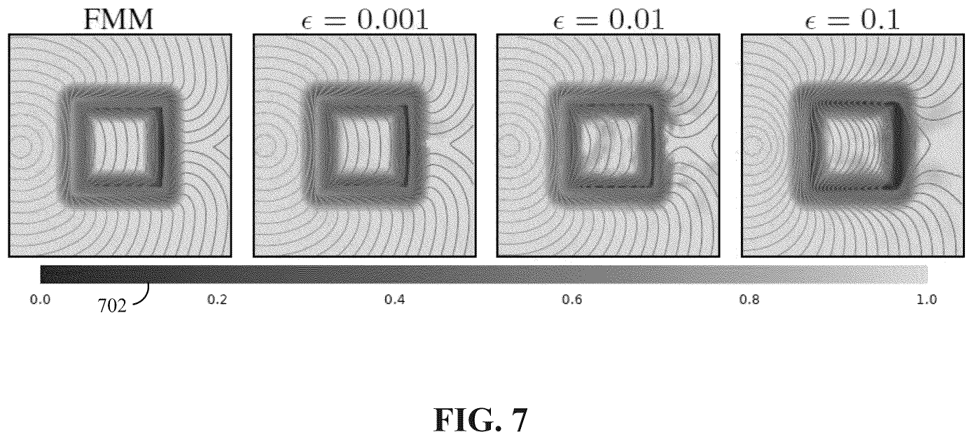

In some examples, Δ_{q}_{_{g}}τ(qₛ, q_{g}) instead of Δ_{q}_{_{g}}T(qₛ, q_{g}) in Equation 7 can be used for computational simplification, which also keeps the similar second-order derivative term. In some examples, the value of e affects the smoothness of the predicted time fields. In FIG. 7, fields can be compared with different values of ε to the ground truth field generated with the FMM approach. The bar 702 shows the speed fields range from 0 to 1. In some examples, it can be seen a large value of ε deviates from the solution given by the expert. The expert is FMM which finds a solution to the Eikonal equation. The colorbar shows the speed fields range from 0 to 1. In further examples, it can be seen that by varying the ε, the correctness of results varies compared to the ground truth. In practice, when the coefficient ε→0, the smooth and unique solution of Equation 6 can approach the exact solution of the Eikonal equation Equation 1. In some examples, Given the τ(qₛ, q_{g}), the gradient, ∇_{q}_{_{g}}τ(qₛ, q_{g}), and Laplacian, Δ_{q}_{_{g}}τ(qₛ, q_{g}), can be computed using auto-differentiation to determine the S(qₛ) and S(q_{g}), as described in Equation 7.

The above formulation resolves some issue of the Eikonal equation. However, computing the Laplacian operator can be computationally expensive as the existing deep learning libraries determine the hessian matrix of τ(qₛ, q_{g}) and its trace to extract Laplacian. To mitigate the computational load, the following two strategies can be employed. First, the viscosity term can be used during the training by setting e to a constant value, and at planning time, ∇_{q}_{_{g}}T(qₛ, q_{g}) and ∇_{q}_{ₛ}T(qₛ, q_{g}) can be computed. Second, the diagonal of the hessian matrix can be directly computed using auto-differentiation following the strategy, resulting in similar complexity as standard gradient forward propagation, which is faster than complete hessian computation in standard deep learning libraries.

At step 218, the process 200 can obtain a ground truth speed indication. In some examples, the ground truth speed indication can be determined based on a parameter depending on a training epoch. In some examples, the ground truth speed indication, denoted as S*(q), at any robot configuration q∈Q can be defined as

$${S}^{*} ( q ) = \frac{{s}_{c o n s t}}{{d}_{max}} \times clip ( {d}_{ℳ} ( p ( q ) , {𝒳}_{o b s} ) , {d}_{min} , {d}_{max} ) , \qquad Equation 8$$

where p⊂ [symbol] ^{m} represents robot surface obtained via forward kinematics for the given configuration q∈ [symbol] _{free}, and [symbol] computes a distance between robot surface p and obstacles [symbol] _{obs} in the workspace. The dₘᵢₙ and dₘₐₓ are minimum and maximum distance thresholds, and s_{const} is a user-defined speed constant. The clip functions bound the distance function with range [dₘᵢₙ, dₘₐₓ]. In some examples, constant speed can be assumed if a robot's distance from obstacles exceeds dₘₐₓ.

In some examples, the ground truth speed indication (S*(q)) can be progressively decreased around obstacles to train physics-informed motion planners in complex environments. The training based on the progressively decreased ground truth speed indication is further described in connection with step 220.

At step 220, the process 200 can train the neural network model based on a loss between the predicted speed indication and the ground truth speed indication. In some examples, N∈ [symbol] different start and goal configuration pairs can be randomly sampled in the given environment and compute their speed field using the ground truth speed indication S*(q) described in Equation 8. The resulting dataset to train the neural network model is of form: {(qₛ, q_{g}, S*(qₛ), S*(q_{g}))¹, (qₛ,q_{g},S*(q_{g}), S*(q_{g}))², . . . , (qₛ, q_{g}, S*(qₛ), S*(q_{g}))^{N}}. In some examples, the loss function to train the neural network model can be computed as follows. For a given start (qₛ) and goal (q_{g}), the neural network model outputs τ(qₛ, q_{g}). Next, the predicted τ(qₛ, q_{g}) can be used to compute the corresponding speed values S(qₛ) and S(q_{g}) using Equation 5. Finally, the neural network model's training loss between the ground truth speed values [S*(qₛ), S*(q_{g})] and the predicted speed values [S(qₛ), S(q_{g})] is defined as:

|1−\sqrt{S*(qₛ)/S(qₛ)}|+|1−\sqrt{S+(q_{g})/S(q_{g})}|+|1−\sqrt{S(qₛ)/S*(qₛ)}|+|1−\sqrt{S(q_{g})/S*(q_{g})}| Equation 9

The loss function can be isotropic to prevent predicted speed from non-uniform errors due to different training sample pairs. Furthermore, a square root can be used to smooth the loss function's gradient. The neural network model can be trained end-to-end with the objective functions (e.g., using an optimizer).

In some examples, during training, weighted random sampling can be used to form batches for our model training during each epoch. The traditional way of forming training batches is randomly sampling a small set of training data for each epoch. However, weighted random sampling of data with sample weights inversely proportional to Euclidean distance between start and goal pairs leads to better performance than traditional random sampling. To train the neural network model end-to-end, the workspace encoder can be gradually introduced as the training epochs increase using a scalar weight λ, i.e., [ƒ(qₛ)⊗ƒ(q_{g}), λg(qₛ)⊗λg(q_{g})]. The λ is set to 0 for the first l₀ epochs, then increased linearly to 1 between epoch l₀ to l₁, and then remains at 1 for the rest of the epochs. In further examples, gradually increasing λ stabilizes the training process, preventing it from converging to local minima. In some examples, \l₀=500, l₁=1000 for Gibson scenes can be chosen.

In some examples, the training based on the progressively decreased ground truth speed indication. In some examples, the physics-based loss functions are generally challenging to optimize as they depend on the gradient of the underlying neural network. In physics-informed motion planners, the optimization becomes more difficult due to low-speed conditions near obstacles, often leading to an incorrect local minimum, i.e., despite small training loss, the neural model behaves as if low-speed obstacles do not exist in the environment. To circumvent the incorrect local minimums, the following two properties of the Eikonal equation can progressively guide the neural network training process and capture the low-speed obstacle space for collision avoidance.

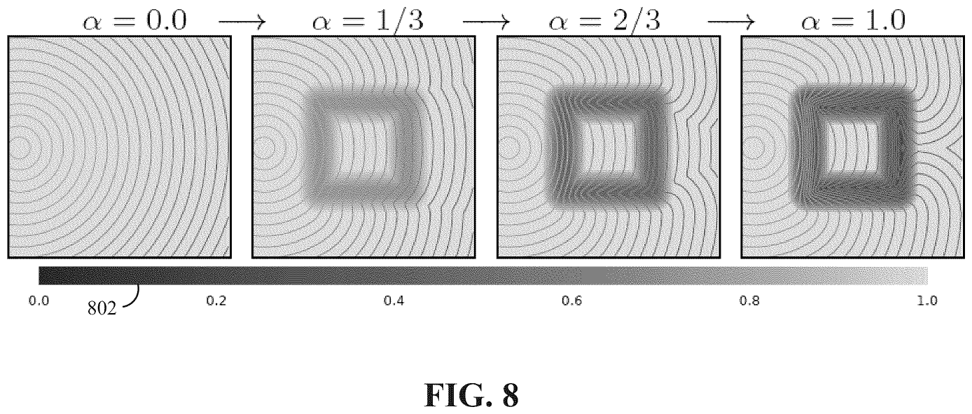

In some examples, the solution of the Eikonal equation (Equation 1), T(qₛ, q_{g}), in a constant max speed scene (S(q)=1) can become the distance between the given start and goal, which leads to trivial solution τ(qₛ, q_{g})=1. In further examples, the interpolation from the constant max-speed to the low speed around obstacles can be continuous, and the solutions of the Eikonal equation along those interpolations can be also continuous. Based on these observations, a progressive speed alteration strategy can be determined. The progressive speed alteration can gradually scale down the speed from a constant max value to a low value around obstacles using a parameter α(t)∈[0,1], i.e.,

$${S}_{α ( t )}^{*} ( q ) = ( 1 - α ( t ) ) + α ( t ) {S}^{*} ( q ) , \qquad Equation 10$$

where t∈ [symbol] represent the training epochs. Therefore, when α(t)=0, the scene will have a constant max speed, and the Eikonal equation solution will be trivial. Furthermore, when α(t)=1, the scene will have low speed around obstacles. α(t)>1 can be made such that the scene's minimal speed will become even lower than sₘᵢₙ. FIG. 8 shows the gradual progression of speed and time fields as a linearly scales from 0 to 1. It can be seen that the speed and time fields are changing continuously with α changing linearly. In FIG. 8, progressively decreasing the speed around obstacles using parameter α leads to continuous interpolation of speed and time fields in the given environment. The bar 802 shows the speed fields range from 0 to 1.

To train the physics-informed motion planner, a low value of α(t) can be started and the neural network can fit a constant speed trivial solution. Next, the field can be progressively interpolated from constant max speed to low speed by gradually increasing the α(t) over the training epochs. The neural network can easily fit the trivial solution. Then progressively decreasing obstacle speed S*(q) guides the network to learn the interpolating lower-speed fields. Furthermore, the speed fields can change linearly with α(t), but the resulting time fields change more aggressively. Thus, the rate of change of α(t) can be reduced as the training epochs increases.

In further examples, since the ground truth speed indication gradually decreased while training, the network parameters can change drastically and forget the previous learning. Several approaches exist to prevent such drastic changes, such as trust region optimization. However, those approaches are often computationally expensive. In some examples, an alternative approach bounds the ratio of loss L at epoch t and t−1 within a threshold η, i.e., (Lₜ/Lₜ₋₁)<η. Whenever the loss ratio exceeds the imposed bound, the training data can be shuffled so that the difficult samples causing high loss values are distributed across different training batches. That way, the average loss does not diverge from the previous loss value and stays within our threshold. In some examples, without such a strategy, the physics-informed neural network can fail to converge and recover the underlying time field.

In some examples, the process 200 can use L1-norm (Equation 9) to compute the isotropic loss function. The L1-norm is not smooth and imposes challenges converging to the optimal solution. Therefore, a new, isotropic objective function can be used, i.e.,

$$L ( {S}_{α}^{*} ( q ) , S ( q ) ) = {S}_{α}^{*} ( {q}_{s} ) / S ( {q}_{s} ) + S ( {q}_{s} ) / {S}_{α}^{*} ( {q}_{s} ) + {S}_{α}^{*} ( {q}_{g} ) / S ( {q}_{g} ) + S ( {q}_{g} ) / {S}_{α}^{*} ( {q}_{g} ) - 4 \qquad Equation 10$$

The new loss is non-negative and has a minimum value of 0. However, the new loss is smooth and can easily reach the minimum value when α is small.

Algorithm 1 Progressive Learning

1: Inputs:

| | |
|---|---|
| D | [symbol] Robot configurations dataset |
| S* (q) | [symbol] Groud truth speed model |
| τ_{θ}( · ) | [symbol] Neural network model |
| θ | [symbol] Model parameters |
| α, step | [symbol] Progressive learning parameters |

| | |
|---|---|
| 2: for i = 1, . . . do | [symbol] Training epoches |

3: α = α + step

| | |
|---|---|
| 4: ${S}_{α}^{*} ( q ) = ( 1 - α ) + α {S}^{*} ( q )$ | [symbol] Compute progressive speed |
| 5: Lᵢ = 0 | [symbol] Begin batch training |
| 6: for batches j = 0, ... do | [symbol] Batch Bⱼ from [symbol] |
| 7: ∀(qₛ, qₛ) ∈ Bⱼ | [symbol] Training data in one batch |
| 8: τ_{θ}(qₛ, q_{g}) | [symbol] Predict factorized time |
| 9: S_{θ}(qₛ), S_{θ}(qₛ) | [symbol] Predict speed by Eq. 7 |
| 10: ${l}_{j} = L ( {S}_{α}^{*} ( q ) , {S}_{θ} ( q ) )$ | [symbol] Compute loss by Eq. 11 |
| 11: θ = θ − ∇_{θ}lⱼ | [symbol] Update model parameters |

12: Lᵢ = Lᵢ + lⱼ

| | |
|---|---|
| 13: if Lᵢ/Lᵢ₋₁ > η then | [symbol] Check loss threshold |

14: Reload i-th epoch model parameters θ
15; Reshuffle samples among batches
16: Repeat batch training steps 5-12

Algorithm 1 outlines an example training pipeline. The inputs to the procedure are described in Line 1, ranging from robot configurations dataset D to neural architecture definition. As the training epoch, denoted by i, increases, the value of α is increased using predefined step sizes (Line 3). Consequently, the ground truth speed model is progressively modified at each training epoch using the parameter α (Line 4). Given the inputs and the ground truth

$${S}_{α}^{*} ,$$

the batch training can start being processed by forming batches from dataset D. The dataset D contains the valid robot start (qₛ) and goal (q_{g}) configurations. For each start and goal pair in batch Bⱼ, the factorized time τ(qₛ, q_{g}) and associated speeds, S(qₛ) and S(q_{g}), can be predicted using Equation 7 (Line 8-9). Next, the loss can be computed between predicted and ground truth speeds (Line 10), and the resulting average batch losses can be aggregated to compute the total dataset loss (Line 12). To prevent neural parameters θ from diverging, the samples can be reshuffled between batches whenever Lᵢ/Lᵢ₋₁>η, where η is a predefined threshold. The reshuffling can be performed to distribute the difficult samples and prevent large gradient-based parameter updates at line 11.

### Example Autonomous Robot Motion Planning Process

FIG. 9 is a flow diagram illustrating an example process 900 for autonomous robot motion planning in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., computing device 110, processor 112 with memory 114, etc.) in connection with FIG. 1 can be used to perform example process 900. However, it should be appreciated that any suitable apparatus or means for carrying out the operations or features described below may perform process 900.

At step 912, the process 900 obtains a start configuration and a goal configuration. In some examples, the start configuration and the goal configuration at step 912 are substantially similar to the start configuration and the goal configuration at step 212 of FIG. 2.

At step 914, the process 900 apply the start configuration and the goal configuration to a trained neural network model to obtain a time field. In some examples, the trained neural network model was trained via steps 212-220 of FIG. 2

At step 916, the process 900 determines a predicted speed indication based on the start configuration, the goal configuration, and the time field. In some examples, the predicted speed indication at step 916 is substantially similar to the predicted speed indication at step 216 of FIG. 2.

At step 918, the process 900 determines a path solution based on the predicted speed indication, the start configuration, and the goal configuration. In some examples, the path solution can be bidirectionally determined by iteratively updating the start configuration and the goal configuration.

For example, once the neural network model is trained, the trained neural network model can be used to parametrize Equation 1, i.e., T(qₛ, q_{g})=∥qₛ−q_{g}∥/τ(qₛ, q_{g}), to compute the time field T(qₛ, q_{g}) and its partial derivatives ∇_{q}_{ₛ}T(qₛ, q_{g}) and ∇_{q}_{_{g}}T(qₛ, q_{g}). The norms of these partial derivatives relate to the speed model as ∥∇_{q}_{ₛ}T(qₛ, q_{g})∥=1/S(qₛ) and ∥∇_{q}_{_{g}}T(qₛ, q_{g})∥=1/S(q_{g}). Since the speed model governs the magnitude of the gradient, the gradient step will be high when speed is low, especially near obstacles, leading to unsafe robot navigation. To mitigate such unsafe maneuvers, we multiple gradients with S²(q), leading to ∥S²(qₛ)∇_{q}_{ₛ}T(qₛ, q_{g})∥=S(qₛ) and ∥S²(q_{g})∇_{q}_{_{g}}T(qₛ, q_{g})∥=S(q_{g}). Since the speed model is small near obstacles, the term S²(q) dynamically scales down the step size near obstacles. Furthermore, the model's symmetry behavior allows to perform gradient steps bidirectionally from start to goal and from goal to start. Hence, we compute the final path solution bidirectionally using iterative gradient descent by updating the start and target configurations as follows, where α∈ [symbol] is a step size hyperparameter.

qₛ←qₛ+αS²(qₛ)∇_{q}_{ₛ}T(qₛ, q_{g}); q_{g}←q_{g}+αS²(q_{g})∇_{q}_{_{g}}T(qₛ,q_{g}) Equation 12

In further examples, once the neural network model is trained, another execution pipeline can be used. First, τ(qₛ, q_{g}) for the given start qₛ, goal q_{g}, and latent environment code b, as described in Equation 3 can be predicted. Next, the factorized time, τ, parameterizes Equations 2 and 5 for computing time T(qₛ, q_{g}) and speed fields S(qₛ), S(q_{g}), respectively. In some examples, Equation 5 instead of Equation 6 for efficient speed computations, i.e., without Laplacian (∈→0). However, it should be appreciated that Laplacian can be computed as well. Finally, the path solution is determined in a bidirectional manner by iteratively updating the start and goal configurations as follows,

qₛ←qₛ−βS²(qₛ)∇_{q}_{ₛ}T(qₛ,q_{g})

q_{g}←q_{g}−βS²(q_{g})∇_{q}_{_{g}}T(qₛ,q_{g}) Equation 12

The parameter β∈ [symbol] is a predefined step size. Furthermore, at each planning iteration, the start and goal configurations are updated using gradients to march toward each other until ∥qₛ−q_{g}∥<d_{g}, where d_{g}∈ [symbol] .

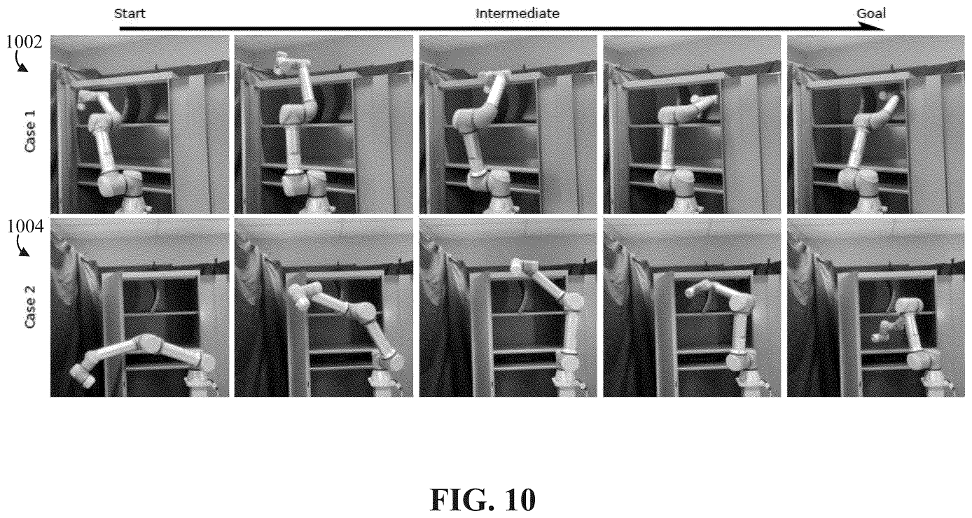

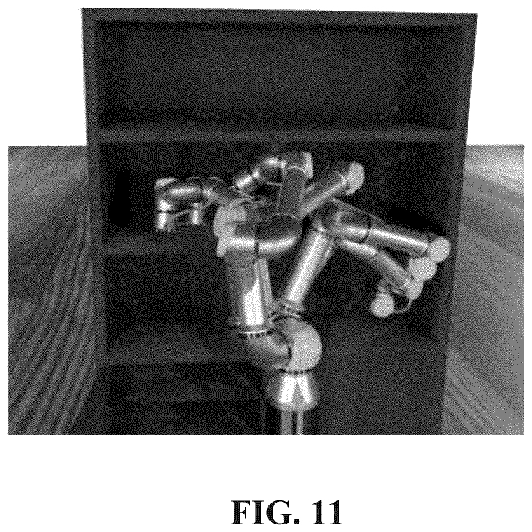

At step 920, the process 900 moves a robot according to the path solution. FIG. 10 shows an example of a robot moving based on the path solution, which is determined by the trained neural network model. The physics-informed neural motion planning of a 6-DOF robot manipulator in a real-world narrow passage environment. The images from left to right show the robot's motion sequence from its start to the desired goal configuration. The first case 1002 shows the manipulator crossing an obstacle at the top level, and the second case 1004 shows the manipulator avoiding the cabinet's door to reach the given target. FIG. 11 shows another example of a robot moving based on the path solution. In FIG. 11, the manipulator crosses two relatively thick obstacles to move from the middle (start) to the bottom (goal) shelf.

### Practical Applications and Example Embodiments

In some examples, moveable devices (such as a robotic arm, an automated vehicle, etc.) can be configured to perform the processes and methods described above and in FIG. 9. In one example, an autonomous robot can use the above-described methods of motion planning to perform repetitive tasks, such as cleaning, moving supplies within a warehouse, gathering and/or assembling parts for a manufacturing process etc. In further examples, a moveable device may use the above-described methods of motion planning to execute tasks in various industries, such as building security, manufacturing and assembly, material processing, household, fulfillment operations, etc. In particular, the device may need to determine motion plans for various paths within a known environment, depending on the start and goal configurations.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for autonomous robot motion planning training, comprising:
obtaining, by an electronic processor, robot configuration training data, the robot configuration training data comprising a start configuration and a goal configuration;
applying, by the electronic processor, the start configuration and the goal configuration to a neural network model to obtain a time field;
determining, by the electronic processor, a predicted speed indication based on the start configuration, the goal configuration, and the time field;
obtaining, by the electronic processor, a ground truth speed indication;
training, by the electronic processor, the neural network model based on a loss between the predicted speed indication and the ground truth speed indication; and
causing a path solution to be loaded onto a robot for movement of the robot within an environment represented by the time field.

2. The method of claim 1, further comprising:
obtaining, by the electronic processor, an obstacle-free configuration space, the obstacle-free configuration space being indicative of a configuration space excluding one or more obstacle configurations;
wherein the start configuration and the goal configuration are on the obstacle-free configuration space.

3. The method of claim 2, wherein the start configuration and the goal configuration are randomly sampled configurations on the obstacle-free configuration space.

4. The method of claim 1, wherein the neural network model comprises a c-space encoder and a time field generator, the c-space encoder for the start configuration and the goal configuration, the time field generator configured to generate the time field, wherein the c-space encoder comprises a first encoder and a second encoder, the first encoder configured to receive a first robot configuration embedding for the start configuration, the second encoder configured to receive a second robot configuration embedding for the goal configuration.

5. The method of claim 4, wherein each of the first robot configuration embedding and the second robot configuration embedding is calculated using a random Fourier technique.

6. The method of claim 4, wherein each of the first encoder and the second encoder comprises a first component, a second component, and a first fully connected layer,
wherein the first component comprises a second fully connected layer and a first exponential linear unit layer, the first component configured to receive the start configuration for the first encoder and the goal configuration for the second encoder and to produce a first component output,
wherein the second component comprises a residual neural network and a second exponential linear unit layer, second component configured to receive the first component output and to produce a second component output, and
wherein the first fully connected layer is configured to receive the second component output and to produce the first robot configuration embedding or the second robot configuration embedding.

7. The method of claim 6, wherein the first component comprises two sets of the second fully connected layer and the first exponential linear unit layer, and
wherein the second component comprises four sets of the residual neural network and the second exponential linear unit layer.

8. The method of claim 4, further comprising: combining, electronic processor, a first output of the first encoder and a second output of the second encoder using a non-linear symmetric operator to produce a combined output.

9. The method of claim 8, wherein the time field generator is configured to receive the combined output and produce the time field.

10. The method of claim 8, wherein the combined output comprises a maximum value in the first robot configuration embedding and the second robot configuration embedding, and a minimum value in the first robot configuration embedding and the second robot configuration embedding.

11. The method of claim 8, wherein the time field generator comprises a first component, a second component, and a third component,
wherein the first component comprises a first fully connected layer and a first exponential linear unit layer, the first component configured to receive the combined output and to produce a first component output,
wherein the second component comprises a residual neural network and a second exponential linear unit layer, the second component configured to receive the first component output and to produce a second component output, and
wherein the third component comprise a second fully connected layer, a third exponential linear unit layer, a third fully connected layer, and a sigmoid layer, the third component configured to receive the second component output and to produce the time field.

12. The method of claim 4, wherein the neural network model further comprises a workspace encoder configured to receive the start configuration and the goal configuration,
wherein the c-space encoder comprises a first component, a second component, and a first fully connected layer,
wherein the first component comprises a second fully connected layer and a first exponential linear unit layer, the first component configured to receive the start configuration and the goal configuration and to produce a first component output,
wherein the second component comprises a residual neural network and a second exponential linear unit layer, the second component configured to receive the first component output and to produce a second component output, and
wherein the first fully connected layer is configured to receive the second component output and to produce a first robot configuration embedding and a second robot configuration embedding.

13. The method of claim 12, wherein the workspace encoder comprises a first component, a second component, and a third component,
wherein the first component comprises a three-dimensional convolution layer and a residual neural network, the first component configured to receive an obstacle grid and to produce a first component output,
wherein the second component comprises a trilinear interpolation layer, the second component configured to receive the start configuration, the goal configuration, and the first component output and to produce a second component output, and
wherein the third component comprises: a first fully connected layer, a first exponential linear unit layer, and a second fully connected layer, the third component configured to receive the second component output and to produce a first robot workspace embedding and a second robot workspace embedding.

14. The method of claim 13, wherein the c-space encoder is configured to produce a c-space encoder output, the c-space encoder output comprising: the first robot configuration embedding and the second robot configuration embedding,
the workspace encoder is configured to produce a workspace encoder output, the workspace encoder output comprising: the first robot workspace embedding and the second robot workspace embedding, and
wherein the method further comprises: combining the c-space encoder output and the workspace encoder output.

15. The method of claim 14, wherein the combined output comprises a first maximum value in the first robot configuration embedding and the second robot configuration embedding, a first minimum value in the first robot configuration embedding and the second robot configuration embedding, a second maximum value in the first robot workspace embedding and the second robot workspace embedding, and a second minimum value in the first robot workspace embedding and the second robot workspace embedding.

16. The method of claim 14, wherein the time field generator comprises a first component, a second component, and a third component,
wherein the first component comprises a first fully connected layer and a first exponential linear unit layer, the first component configured to receive the combined output and to produce a first component output,
wherein the second component comprises a residual neural network and a second exponential linear unit layer, the second component configured to receive the first component output and to produce a second component output, and
wherein the third component comprise a second fully connected layer, a second exponential linear unit layer, a third fully connected layer, and a sigmoid layer, the third component configured to receive the second component output and to produce the time field.

17. The method of claim 1, wherein the determining of the predicted speed indication comprises:
determining an arrival time model based on the time field, the start configuration, and the goal configuration; and
determining the predicted speed indication based on a partial derivative of the arrival time model with respect to the goal configuration.

18. A system for autonomous robot motion planning, the system comprising:
a robotic device having at least one drive mechanism for moving at least a part of the robot;
an electronic processor in communication with the robotic device;
a memory in communication with the processor and having instructions stored thereon that, when executed cause the processor to:
obtain, by the electronic processor, a start configuration and a goal configuration;
apply, by the electronic processor, the start configuration and the goal configuration to a trained neural network model to obtain a time field;
determine, by the electronic processor, a predicted speed indication based on the start configuration, the goal configuration, and the time field;
determine, by the electronic processor, a path solution based on the predicted speed indication, the start configuration, and the goal configuration; and
move, by the electronic processor, the robotic device according to the path solution.

19. The system of claim 18, wherein the trained neural network model comprises a space-space encoder and a time field generator, the c-space encoder for the start configuration and the goal configuration, the time field generator configured to generate the time field.

20. The system of claim 18, wherein the robotic device is a robotic arm operating within an environment represented by the time field.
